(19) United States
(12) Patent Application Publication
(10) Pub. No.: US 2021/0317926 A1
(43) Pub. Date: Oct. 14, 2021

(54) FLUID MIXING VALVE

(71) Applicant: GWC Group Pty Ltd ATF GWC Group Trust, Red Hill, Queensland (AU)

(72) Inventor: Simon Matthew Nash, Red Hill, Queensland (AU)

(21) Appl. No.: 17/267,522

(22) PCT Filed: Aug. 2, 2019
(86) PCT No.: PCT/AU2019/050813

§ 371 Date: Feb. 10, 2021

(30) Foreign Application Priority Data
Aug. 10, 2018 (AU) 2018902919
Feb. 6, 2019 (AU) 2019900367

(51) Int. Cl. F16K 31/00; F16K 11/07; G05D 23/13; F16K 27/12

(52) U.S. Cl. CPC F16K 31/002; F16K 11/0716; F16K 27/12; G05D 23/1353; G05D 23/134

(57) ABSTRACT

Provided is a valve for mixing fluids, the valve including a manifold having a cartridge mount and a cartridge being mountable in the cartridge mount, and a first fluid inlet channel and a second fluid inlet channel; the first fluid inlet channel and second fluid inlet channel in fluid communication with a mixing chamber of the cartridge; an outlet of the cartridge mount being in fluid communication with the mixing chamber, such that the outlet can receive mixed fluid from the first fluid inlet channel and the second fluid inlet channel; and wherein the cartridge is removable from the cartridge mount.

### CROSS-REFERENCE TO RELATED APPLICATIONS

This application claims priority to PCT Application No. PCT/AU2019/050813, having a filing date of Aug. 2, 2019, based on Australian Provisional Application No. 2019900367, having a filing date of Feb. 6, 2019, and Australian Provisional Application No. 2018902919, having a filing date of Aug. 10, 2018, the entire contents of all of which are hereby incorporated by reference.

### FIELD OF TECHNOLOGY

The following relates to a valve for mixing fluids from one or more inlets. More particularly, the following relates to a tempering valve or an isolation valve for mixing fluid.

### BACKGROUND

Valves are used for a number of applications, but are generally used to restrict the flow of fluids or divert the flow of fluids. Common systems which use valves are particulate material transport systems, water systems, and gas delivery systems.

Residential, commercial and industrial structures will have a number of valves, particularly for sinks, showers, baths and other systems which require the control of fluids. Shower bath systems that draw heated water from a hot water supply frequently incorporate thermostatically controlled mixing valves or tempering valves in order to control the temperature of water to the fixture by allowing the hot water to mix with a controlled flow of cold water from the mains supply. These types of valves are commonly disposed on the exterior of a hot water system or mounted in cabinets or off-wall where they can be accessed for temperature setting, and general maintenance. Such valves may be formed with a T-shape, with a hot fluid and a cold fluid meeting at the middle of the valve and the two fluids mixing before being expelled from an outlet pipe.

As the valves for systems are generally required to be exposed, they have a high potential to be impacted by external forces and be damaged. Further, to install these devices, a number of compression joints are generally required to allow for fitting of the valve in the fluid paths. Having a large number of compression joints increases the potential for seals to deteriorate and failures to occur with more complex component structures.

There are a number of different types of valves which can be used for mixing of fluids, however these valves generally have the aforementioned disadvantages. Over the years numerous attempts have been made to design a valve for mixing hot and cold water and provision of a stable output temperature.

A number of known valves are discussed in the following documents. British Pat. Nos. 885,752 and 1,108,580 disclose mixing valves in which a duplex cone valve controls the flow of hot and cold water into the valve mixing chamber. British Pat. Nos. 969,925, 1,328,659, 1,407,512 and 1,496,329 disclose valves in which the supply of hot and cold water into the mixing chamber is controlled by various forms of pistons slidable within sleeves contained in the valves to effect the opening and closure of apertures formed in the walls of the sleeves and through which the hot and cold water pass on-route for the mixing chamber. Generally, the pistons are urged into positions that close the apertures communicating with a cold water inlet by spring means and into positions that close the apertures communicating with a hot water inlet by a temperature responsive device positioned in the mixing chamber. However, these devices are generally complex and may provide for a number of failure regions. Further, accessing these valves to test pressures and clean fluid conduits can be difficult, or require complete removal of the valve before pressure testing can be conducted.

In view of the above, it may be advantageous to provide for a valve which can reduce the number of regions which require compression joints. Further, it may be advantageous to provide for a valve which can be protected and/or concealed. In addition, it may be advantageous to provide for a valve which can provide for testing of fluid channel pressures without removal of the valve body from a fixed position.

Current tempering valves allow for the possibility for either plumbers or end users easy access to remove the device and connect a bypass system from the hot water supply t the tempered inlet line. This can be problematic as this will conflict with some jurisdictional regulatory requirements.

Any discussion of the conventional art throughout the specification should in no way be considered as an admission that such conventional art is widely known or forms part of common general knowledge in the field.

### SUMMARY

An aspect relates to a device which may allow for testing of fluid pressure.

An aspect relates to a device which removes the need for installation of multiple components.

An aspect relates to a device which reduces the number of compression joints required for installation of a valve.

An aspect relates to a device with a removable cartridge without complete removal of a valve.

An aspect relates to a device which conceals a commercial or residential valve.

An aspect relates to an embeddable valve.

An aspect relates to a device with a reduced exposed profile.

It is an object of embodiments of the present invention to overcome or ameliorate at least one of the disadvantages of the conventional art, or to provide a useful alternative.

An aspect of embodiments of the present invention may relate to a valve for mixing fluids, the valve comprising a manifold having a cartridge mount and a cartridge being mountable in the cartridge mount, and a first fluid inlet channel and a second fluid inlet channel. The first fluid inlet channel and second fluid inlet channel in fluid communication with a mixing chamber of the cartridge. An outlet of the cartridge mount being in fluid communication with the mixing chamber, such that the outlet can receive mixed fluid from the first fluid inlet channel and the second fluid inlet channel; and wherein the cartridge is removable from the cartridge mount.

In an embodiment, the cartridge mount has a first channel portion and a second channel portion, and the cartridge has a corresponding first channel portion and a corresponding second channel portion, in which the first channel portion of the cartridge mount and the corresponding first channel portion of the cartridge form the first fluid inlet channel, and the second channel portion of the cartridge mount and the corresponding second channel portion of the cartridge form the second fluid inlet channel.

In an embodiment, a respective interface seal is disposed between the first channel portion and the corresponding first portion form the first fluid inlet channel, and between the second channel portion and the corresponding second channel portion form the second fluid inlet channel.

In an embodiment, at least one of the corresponding first channel portion and the corresponding second channel portion comprise a cavity.

In an embodiment, a non-return valve can be inserted in the cavity.

In an embodiment, the manifold comprises a recess which allows for expansion and contraction of the outlet.

In an embodiment, the manifold further comprises an attachment plate for fixing the manifold to a substrate.

In an embodiment, a manifold housing is mountable over the manifold.

In an embodiment, a faceplate is mountable around a portion of the manifold housing.

In an embodiment, the valve is adapted to be at least partially mounted in a wall.

In an embodiment, the first fluid inlet channel and second fluid inlet channel are in fluid communication with a hub.

In an embodiment, an adjustment means is disposed in the hub and mixing chamber of the cartridge.

In an embodiment, the adjustment means comprises an element and piston assembly.

In an embodiment, a piston of the element and piston assembly is adapted to expand and contract in response to temperature changes.

In an embodiment, the adjustment means is adjustable to control a maximum temperature of fluids in the mixing chamber.

In an embodiment, the first fluid inlet channel and the second fluid inlet channel may be disposed on opposed sides of the hub at an angle 45 degrees to the horizontal plane of the hub.

Alternately, the first fluid inlet channel and the second fluid inlet channel may be disposed on opposed sides of the hub at an angle parallel to the horizontal plane of the hub.

According to a further aspect of embodiments of the present invention there is provided a method for installing a fluid mixing valve comprising:

installing a cartridge mount to a substrate of a building, the cartridge mount including at least first and second fluid inlets and an outlet for a mix of fluids from the first and second fluid inlets and a cartridge housing for receiving a cartridge for mixing fluids from the first and second fluid inlets;

sealing the cartridge housing;

connecting first and second fluid pipes to the first and second fluid inlets and an outlet pipe to the outlet for the mix of first and second fluids;

pressure testing connections of the first and second fluid pipes and the outlet pipe to the cartridge mount whilst the cartridge housing is sealed;

upon a successful pressure test unsealing the cartridge housing and installing the cartridge therein; and

applying a panel over or about a portion of the sealed cartridge housing subsequent to the pressure testing and prior to installing the cartridge.

In the context of embodiments of the present invention, the words “comprise”, “comprising” and the like are to be construed in their inclusive, as opposed to their exclusive, sense, that is in the sense of “including, but not limited to”.

Embodiments of the invention are to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION

Some of the embodiments will be described in detail, with reference to the following figures, wherein like designations denote like members, wherein:

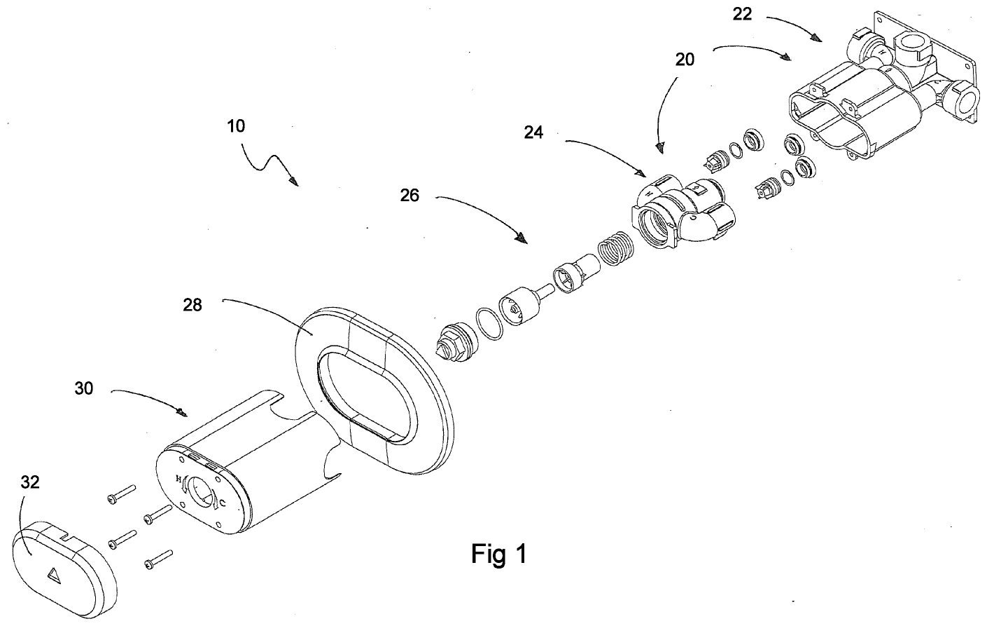

FIG. 1 is an exploded view of an embodiment of a valve of the present disclosure;

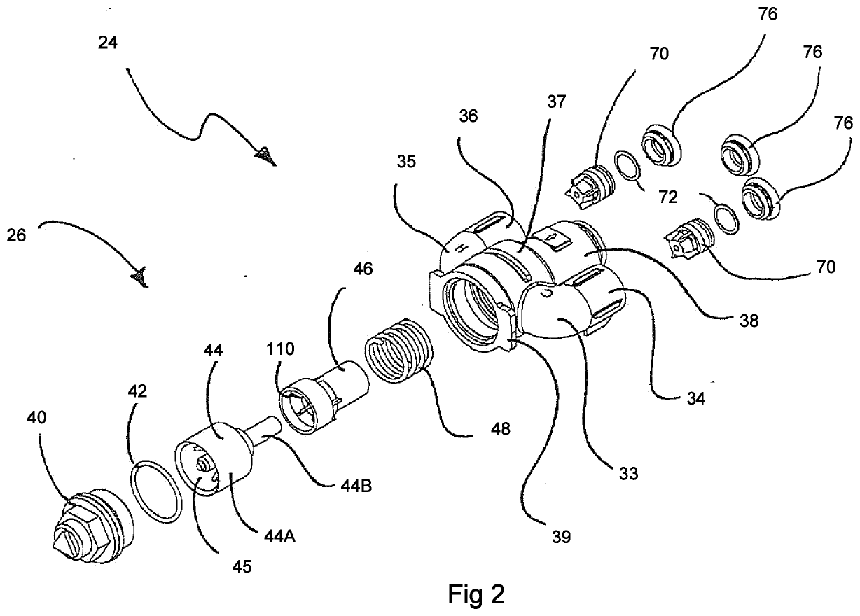

FIG. 2 is an exploded view of an embodiment of a valve cartridge which forms a portion of a manifold of the valve;

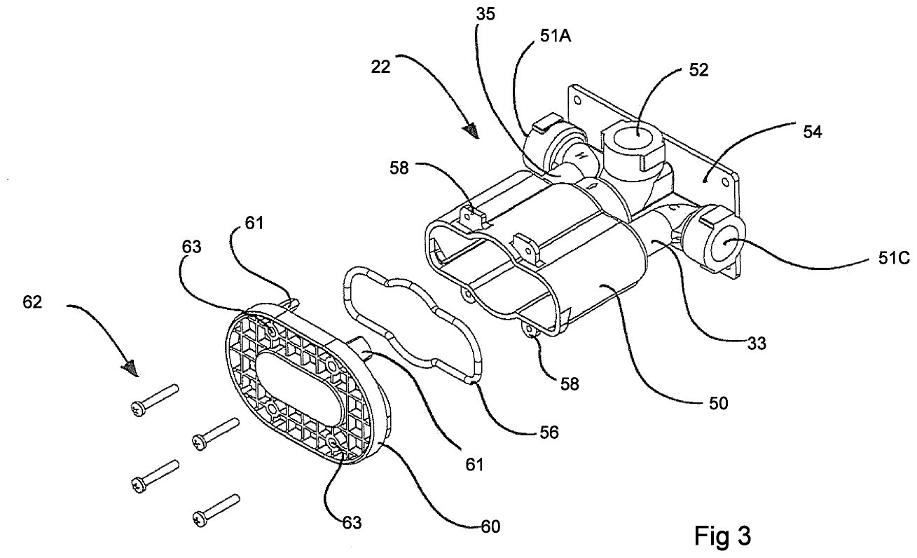

FIG. 3 is an exploded view of a cartridge mount of the manifold with a housing adapted to receive a valve cartridge and a temporary manifold housing plate for pressure testing fluid connections to the cartridge mount;

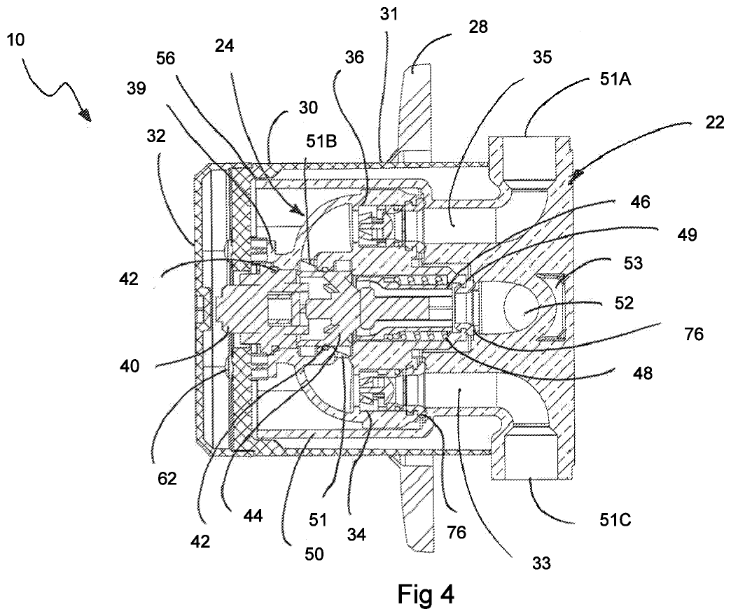

FIG. 4 is a sectional top view of the valve;

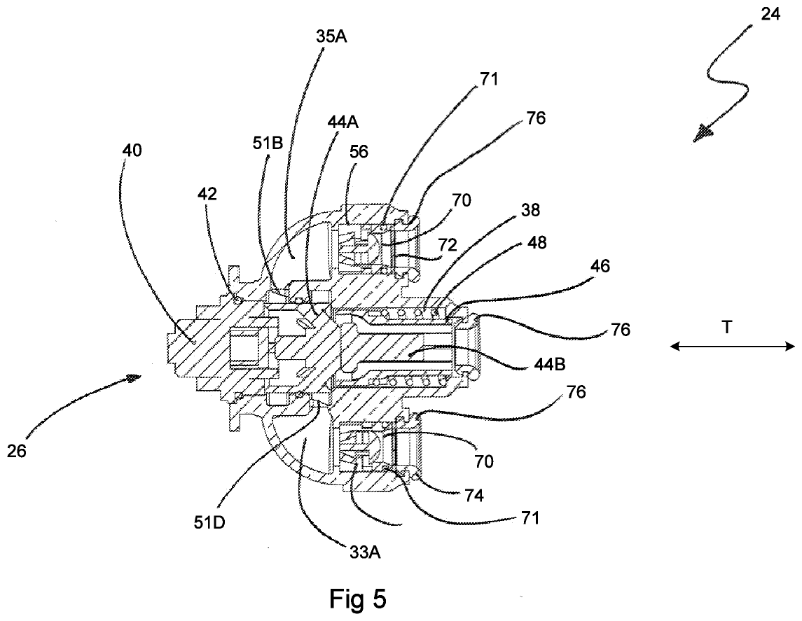

FIG. 5 is a sectional top view of an embodiment of a cartridge of the manifold of the valve;

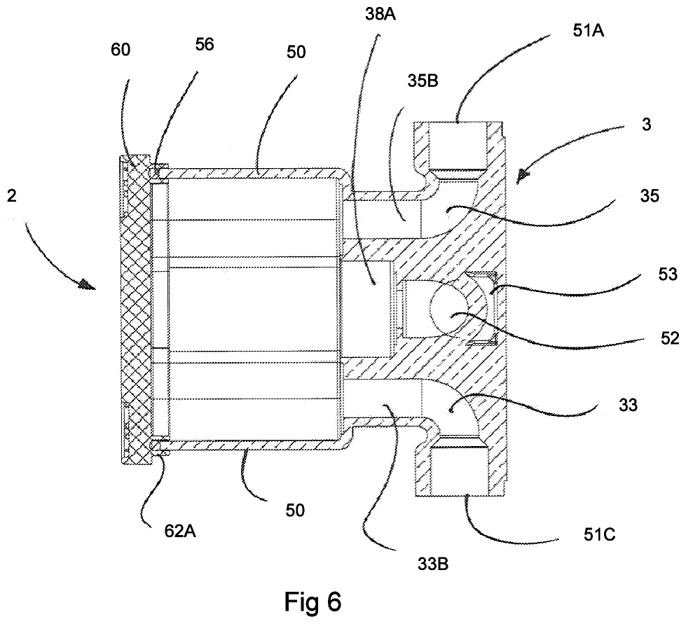

FIG. 6 is a sectional top view of an embodiment of a cartridge mount of the manifold of the valve;

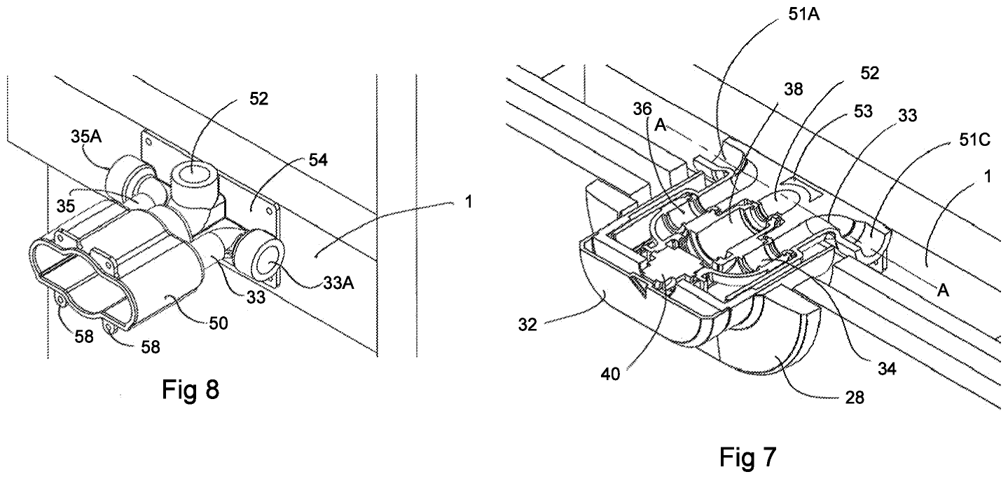

FIG. 7 is a sectional view of the valve installed in a wall;

FIG. 8 is a perspective view of the cartridge housing of the valve mounted on a substrate;

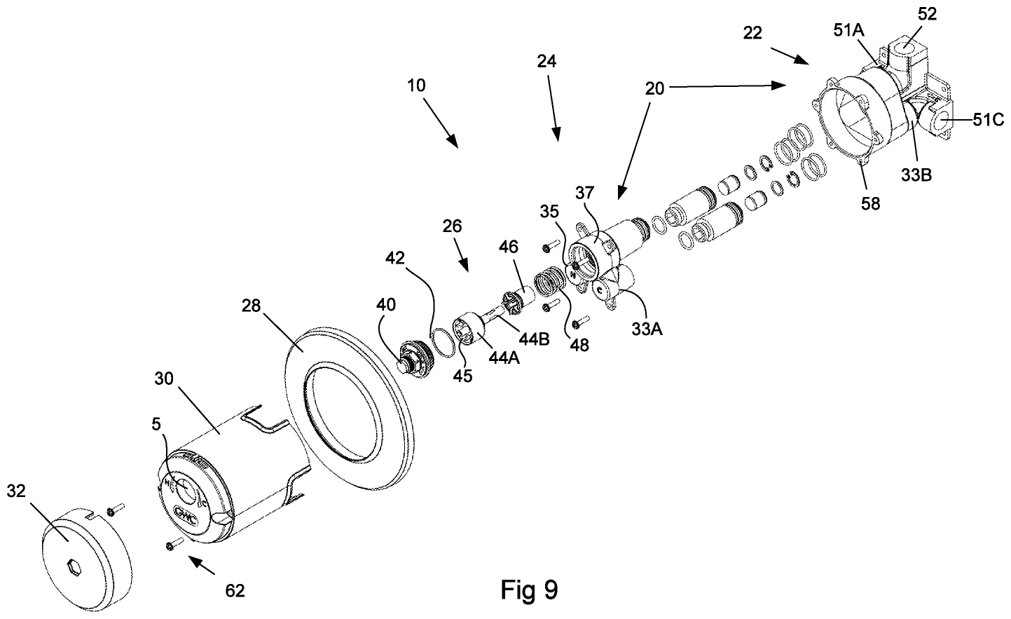

FIG. 9 is an exploded view of another embodiment of a valve of the present disclosure which has a general circular or cylindrical profile;

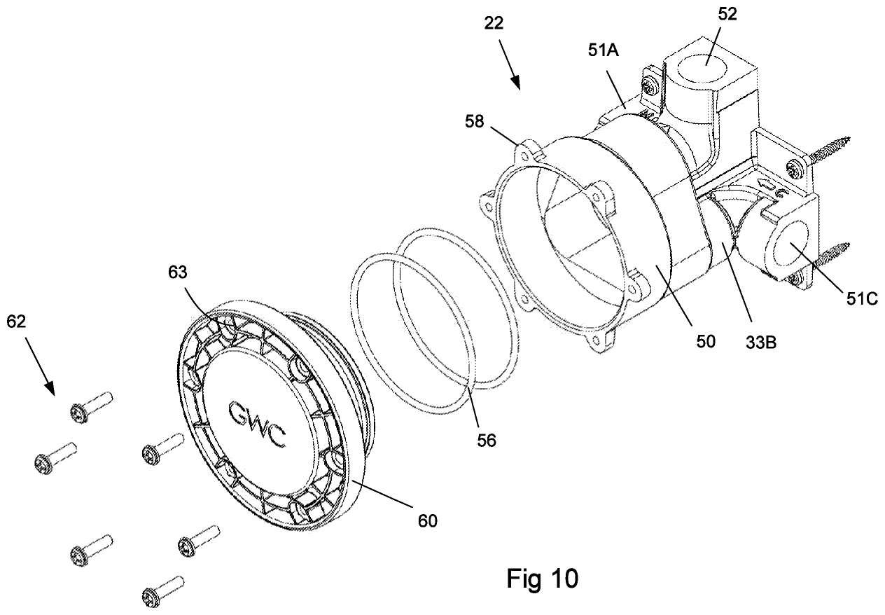

FIG. 10 is an exploded view of a cartridge mount of the manifold of the valve of FIG. 9 with a housing adapted to receive a valve cartridge and a temporary manifold housing plate for pressure testing fluid connections to the cartridge mount of the valve;

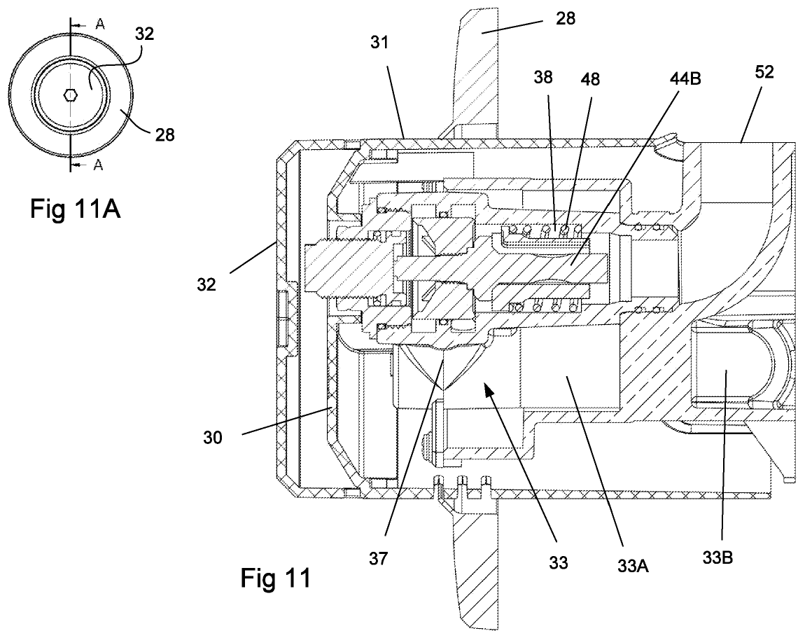

FIG. 11 is a sectional side view of the valve of FIG. 9 in an assembled state along the line A-A of FIG. 11A;

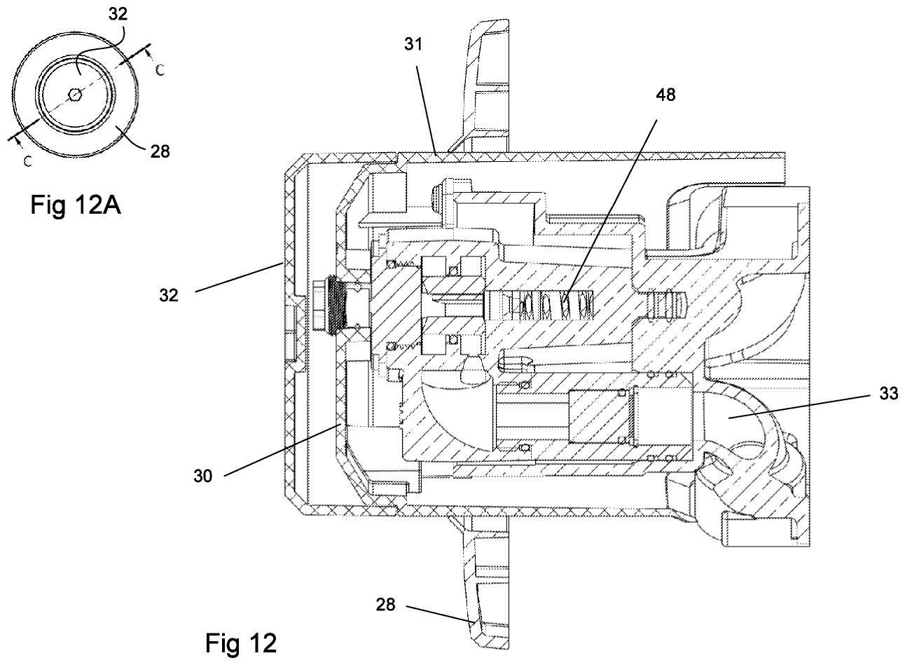

FIG. 12 is a further sectional view of the valve of FIG. 9 in the assembled state along line C-C of FIG. 12A;

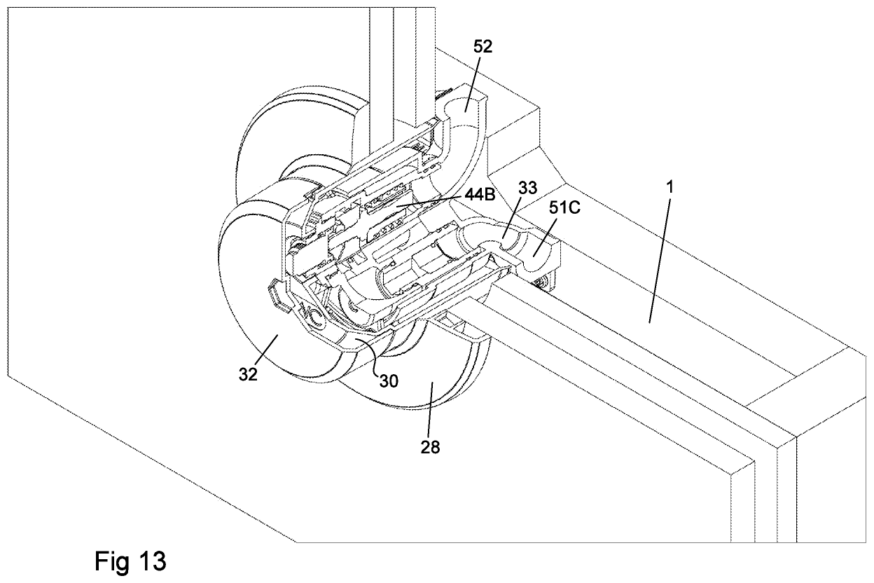

FIG. 13 is a partially cutaway view of the valve of FIG. 9 including cap and faceplate installed on a substrate in the form of a wall;

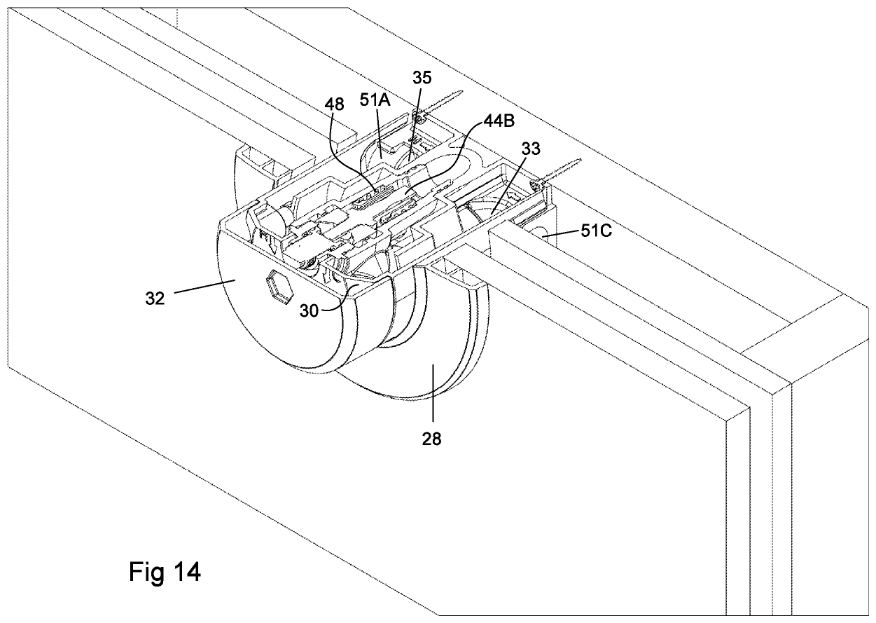

FIG. 14 is a sectional view of the valve of FIG. 9 including cap and faceplate installed on a substrate in the form of a wall.

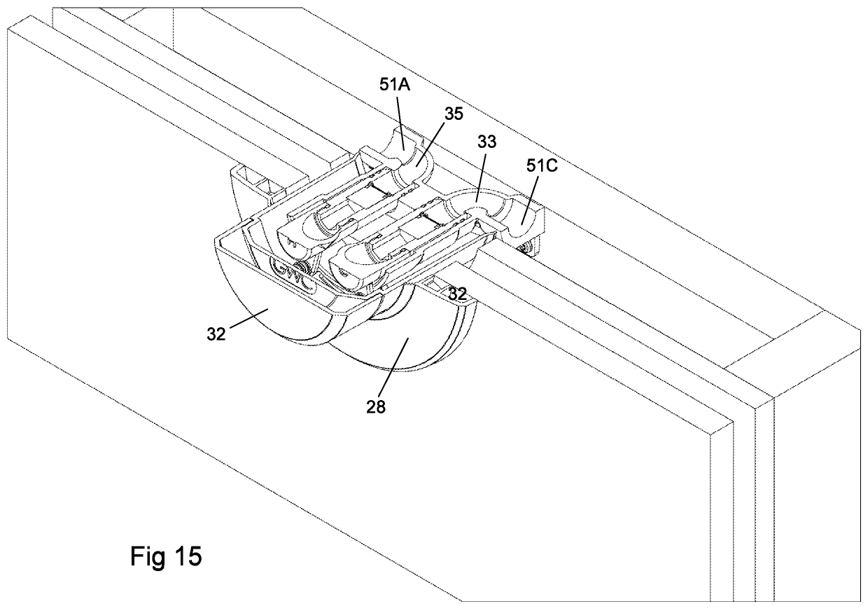

FIG. 15 is a view through a further section, being at a lower level to that of the section of FIG. 14, of the valve of FIG. 9 including cap and faceplate installed on a substrate in the form of a wall;

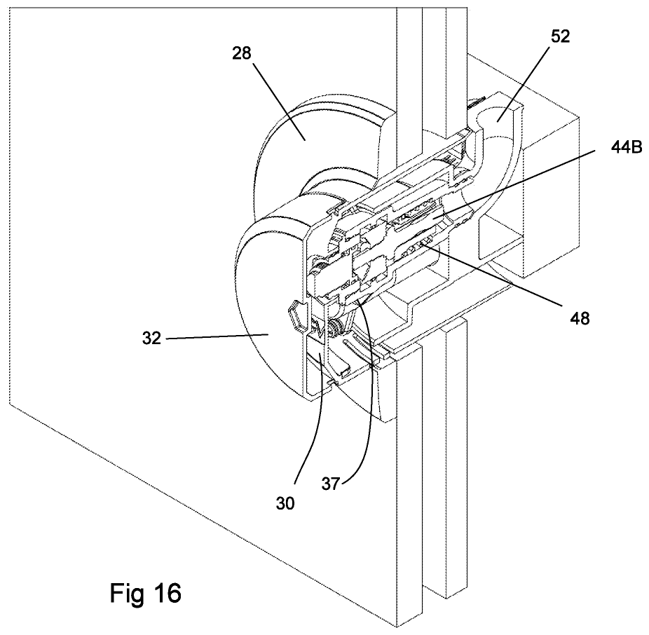

FIG. 16 is a view through a further section, being at right angles to the section of FIG. 14, of the valve of FIG. 9, including cap and faceplate installed on a substrate in the form of a wall;

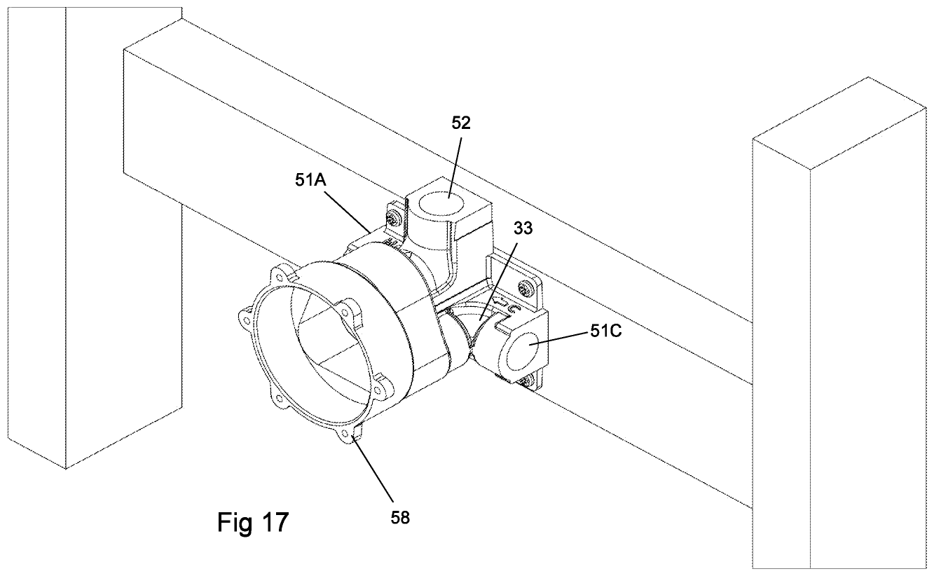

FIG. 17 is a perspective view of the cartridge housing of FIG. 9;

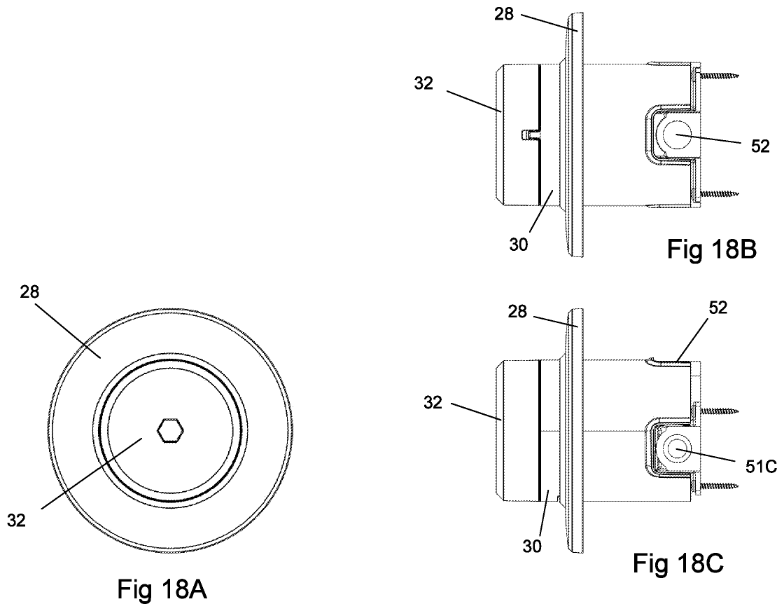

FIG. 18A is an end view of the valve of FIG. 9 looking toward an outside of the end cap 32;

FIG. 18B is a top, assembled view of the valve of FIG. 9; and

FIG. 18C is a right, assembled view of the valve of FIG. 9.

### DETAILED DESCRIPTION

Preferred embodiments of the invention will now be described with reference to the accompanying drawings and non-limiting examples.

In accordance with one embodiment a mixing valve 10 of the present disclosure is provided, the valve 10 includes a manifold 20, and an adjustment means and/or temperature-responsive device 26. The manifold 20 defines inlets, in the presently described embodiment comprise a first fluid inlet channel in the form of a cold fluid channel 33, and a second fluid inlet channel in the form of a hot fluid channel 35. The valve 10 further includes a mixing chamber 38 in fluid communication with the cold fluid channel 33, the hot fluid channel 35, and a fluid outlet 52 in fluid communication with the mixing chamber 38. The temperature-responsive device 26 is capable of regulating the relative volumes of flow from the fluid inlets to the mixing chamber 38, and therefore to control the flow to the outlet 52. In an embodiment, the manifold 20 is formed from two distinct components, a cartridge mount 22 which connects to infrastructure or fixtures of a structure, and a cartridge 24 which is mountable in the cartridge mount 22.

Referring to FIG. 1, there is illustrated an exploded view of an embodiment of a valve. The valve 10 comprises a manifold 20 formed from cartridge mount 22 and a cartridge 24. In an embodiment, the cartridge 24 is removable from the cartridge mount 22, such that the pressure at installation of fluid channels can be checked, and/or the fluid channels can be flushed, and/or the fluid channels can be cleaned. In an embodiment an adjustment means 26, which is also temperature responsive, is installable in the cartridge 24 of the manifold 20. The adjustment means 26 being adapted to regulate or adjust fluid temperature to an outlet of the valve. A manifold housing 30 may be disposed over the manifold 20. The manifold housing 30 may be secured to the manifold 20 via an attachment means 62. A faceplate 28 ay be disposed around a portion of the manifold housing 30 and may be used to conceal an aperture or hold in a wall or other substrate. An end cap 32 may be attached to a proximal end of the manifold housing 30 which covers the adjustment group 40 of the adjustment means 26.

As can be seen in FIG. 2, the cartridge 24 is in a trident type configuration, with the first and second fluid inlet channels 33A and 33B and mixing chamber 38 all generally parallel with each other. Each of the channels 33A, 33B and mixing chamber 38 is in communication with a hub 37 that is formed with a cavity which is adapted to house the head 45 element 44A of the element and piston assembly 44 of the adjustment means 26. A hub plate 39 is disposed proximally of the hub cavity 37, and the hub plate 39 is adapted to support an adjustment group 40 of the adjustment means 26, and also abut a central portion of the manifold housing 30. In this way the manifold housing 30 can be supported by the hub plate 39.

As may be seen in FIG. 5, each of channels 33A and 35A may have a respective cavity; a first channel cavity 34, and a second channel cavity 36. At least one of cavities 34 and 36 may be adapted to receive a non-return cartridge 70 and stainless steel strainer 72. The non-return cartridge 70 may be any conventional non-return cartridge 70 or non-return means 70. An O-ring 71 or other gasket 71 may be disposed at one end of the non-return cartridge 70 which may assist with reducing fluid leaks and provide a fluid tight fit between the fluid channel cavity and the non-return valve 70, such that movement of the non-return valve 70 is reduced when in use. The non-return cartridges restrict or prohibit the flow of fluid in at least one direction such that fluids do not mix undesirably. A grommet 74 and/or filter 74 may be disposed at the distal end of cartridge 24 and at the outlet of the mixing chamber 38. The grommet 74 which may provide a seal between the cartridge 24 and the cartridge mount 22, and thereby act as an interface seal 74. The grommet 74 may also be used as a stopper or retaining means for the non-return cartridge installed in a cavity 34 and/or 36. The grommets 74 may be mounted in an annular flange 76 at the distal end of a respective cavity, and/or the mixing chamber 38. The annular flanges 76 may retain the grommets 74 in a desired location for mounting the cartridge 24 in the cartridge mount 22. Each annular flange may be of a predetermined size, and in embodiments, each annular flange is sized to correspond with a respective channel of a cartridge mount 22.

Valve 10 comprises a device that includes an element and piston assembly 44, and a mixing tube 46 disposed in the mixing chamber 38. The shaft of the piston 44B is disposed in the mixing tube 46 which can be axially displaceable relative to the mixing tube 46. The element 44A comprises an annular bottom sealing surface and an annular top sealing surface. Sealing surfaces 45A and 45B of the head 45 are configured to engage the distal end of the hub 37 and the distal end of the adjustment group 40, respectively. Surfaces 45A and 45B are generally configured to controllably restrict flow of fluids from the channels to other parts of valve 10.

The piston 44B is supported in the mixing tube 46, and mixing tube 46 is supported by a return spring 48 located in the mixing chamber 38. In an embodiment, element 44A further defines a plurality of openings (not shown) and a central lumen in fluid communication with the mixing tube 46. When the openings align, or partially align with channel outlets 33B and 335B, the element is considered to be “open”. Central lumen extends through the length of the element 44A and the mixing tube 46 and through to outlet 52.

The element 44A allows for fluids to pass from the first and second channels 33, 35 into the hub, and through to the mixing tube 46 when the valve 10 is open. Optionally, the valve 10 may be closed which prevents mixing of fluids from the first and second channels. Alternatively, when the valve is closed, fluids may be mixed, but repented from exiting the mixing chamber 38 to outlet 52. A relative location of the pressure release piston 44B (may also referred to as a ‘poppet’) of the element and piston assembly 26 may be adjusted by manipulation of the adjustment group 40. As the adjustment group 26 is turned, the piston 44B may be moved axially within the mixing chamber 38. As the piston 44B axially moves, the mixing tube 46 may also move axially in the mixing chamber 38 relative to the piston 44B. In an embodiment, the displacement of the piston 44B and the displacement of the mixing tube 46 in the mixing chamber and/or hub corresponds to the movement of the adjustment group 40. The spring external the mixing tube may bias the mixing tube 46 against the piston 44B, such that changes in the size of the piston or rotation of the adjustment group 40 retains the piston 44B is a desired location in the mixing tube 46.

The outlet of fluid channel 33 is defined by opening 33B, and the outlet of fluid channel 35 is defined by opening 35B. The outlet openings 33B and 35B of the channels 33, 35 are in fluid communication with hub 37 when the element 44A is open. Openings 33B and 35B proximal the hub align with side openings of element 44A; and top openings 51B, 51D are in fluid communication with the lumen defined by the lumens of the element 44 and the mixing tube 46. Optionally, pressure relief piston 44B defines a piston lumen (not shown) extending through its length. In an embodiment, pressure relief piston 44B is cylindrical such that it slides within lumen 47 of the mixing tube 46. Sliding within the lumen 47 may include an expansion and contraction. When the fluids within the mixing chamber are too hot, the piston may expand axially such that the distal end of the piston (also referred to as sealing surface 86) substantially closes off, or fully closes off, fluid communication between the mixing chamber and the outlet 52.

As previously discussed, the cartridge 24 is in a trident type configuration, with the inlet channels and mixing chamber 38 all generally parallel with each other. Each of the channels 34, 36 and mixing chamber is in communication with a hub cavity 37 which is adapted to house the head 45 element 44A of the element and piston assembly 44 of the adjustment means 26. A hub plate 39 is disposed proximally of the hub cavity 37, and the hub plate 39 is adapted to support the adjustment group 40 of the adjustment means 26, and also abut a central portion of the manifold housing 30. In this way the manifold housing 30 can be supported by the hub plate 39. A spring 48 can be seated in the mixing chamber and a mixing tube 46 seated in the spring 48. The spring 48 may provide a biasing force such that the mixing tube 46 can be forced or otherwise urged against the element and piston assembly 44. With the spring 48 biasing the mixing tube 46 against the element and piston assembly 44, relative movement of the piston can cause relative movement of the mixing tube 46. It will be appreciated that the piston 44B may be adapted to expand and contract without movement of the mixing tube 46, or at least without significant movement of the mixing tube 46. Significant movement of the mixing tube can be effected by manipulation of the adjustment group 40.

An O-ring, gasket or other seal 42 may be provided and mounted about the head 45 of the element 44A and/or about the adjustment group 40. Further, head 45 comprises an aperture which can seat the adjustment group 40. The adjustment group 40 is adapted to abut and axially displace the piston 44B of the element and piston assembly 44 in the mixing chamber. It will be appreciated that the axial direction of movement for the piston 44B is parallel, or substantially parallel, to the longitudinal axis of the lumen of the mixing chamber. A manipulation means of the adjustment group 40 provides for the axial movement of the element and piston assembly 44 of the adjustment means 26. Namely, the piston 44B is abutting the adjustment group 40, and rotation or axial movement of the adjustment group 40 can cause the piston 44B to move axially. The head 45 of element 44A comprises at least one fluid aperture or fluid intake which allows fluids from the first and second channels to enter into the head 45. The head 45 may comprise further fluid apertures which allow fluids to pass from the head into the mixing chamber 38, and in an embodiment, into the mixing tube 46 and around the piston 44B. The piston 44B may also expand and contract based on temperature changes in the mixing chamber 38.

In an embodiment, the wall(s) of the head 45 are bound by the adjustment group 40 and a distal end of the hub cavity 37. The proximal end of the device 10 is the end near to the adjustment means 26 and the distal end is near to the attachment plate 54. As the wall(s) of the head 45 are bound, axial movement of the element 44A is restricted or prevented, such that movement of the adjustment group only imparts an axial movement of the piston 44B of the element and piston assembly 44, and axial movement is not imported to element 44A. As the piston 44B moves axially towards the outlet channel 52 (see FIG. 4), the spring 48 is compressed and when the piston 44B moves axially away from the outlet chamber 52, the spring 48 can expand and cause the mixing tube 46 to move in the direction of the piston 44B.

Referring now to FIG. 3, there is shown a cartridge mount 22 of the manifold 20. The cartridge mount 22 comprises a first channel 33B and a second channel 35B. An outlet channel 52 is provided between the channels 33B and 35B. In an embodiment, the apertures 51 of the inlets and the outlet are all in the same plane. The entry apertures of the inlet channels 51 may be on opposing sides of the manifold 20, and the outlet 52 may be disposed between the inlet channels. In this way, the profile of the manifold 20 can be reduced compared to known devices. Further, this configuration allows pipes or channels to make with the inlets and outlets of the manifold 20 at a focal point which can be contained in the cavity of a wall. In an embodiment, the inlet apertures 51 have a common axis which is illustrated by line A-A in FIG. 7.

Referring again to FIG. 3, a plurality of anchor locations 58 are shown disposed on the cartridge housing 50 which are adapted to receive securing means 62 for securing a manifold housing 30. Each anchor location 58 may receive a discrete securing means 62. The anchor locations 58 may project perpendicularly from the cartridge housing 50. A gasket 56 may be disposed between the cartridge housing 50 and the manifold housing 30.

As illustrated in FIG. 3, the rear of a temporary manifold housing plate 60 is shown which is used without the manifold housing 30 and without cartridge 24. A plurality of alignment means 61 are also disposed on the rear of the temporary manifold housing plate 60 which assist with installation to the cartridge housing 50 of cartridge mount 22. The alignment means 61 may allow for correct mounting of the manifold housing 30 onto the cartridge housing 50. A plurality of securing means apertures 63 may be provided in the temporary manifold housing plate 60 in which securing means 62 may be mounted or inserted, which are subsequently secured to anchor locations 58. The anchor locations 58 may also have corresponding apertures to allow the securing means 62 to secure to each of the temporary manifold housing plate 60 and the manifold housing 30 to the cartridge housing 50. Alternatively, a tongue in groove system or similar securing system may be used instead of a separate securing means passing through apertures. For example, referring to FIG. 6, a temporary manifold housing plate 60 is shown mounted on the proximal portion of the cartridge housing 50 via securing clips 62A adjacent the gasket 56.

A gasket 56 or other seal may be provided between the temporary manifold housing plate 60 and the cartridge housing 50 of manifold 20 to prevent or limit fluid passing between the temporary manifold housing plate 60 and the cartridge housing 50 undesirably during pressure testing. The temporary manifold housing plate 60 is used to seal the cartridge mount 22 to allow pressure-testing of fluid connections to the inlets 51C and 51A and the outlet 52 prior to installing the cartridge 24 into the cartridge mount 22. The rear of the temporary manifold housing plate 60 may have a depression or formation (such as securing clips 62A) adapted to receive the gasket 56. It will be appreciated that gasket 56 may only be present when the temporary manifold housing plate 60 is installed. In an embodiment, if a depression or other formation is provided, the formation conforms to the shape of the proximal rim of the cartridge housing 50. The gasket 56 may be disposed between the rim of the cartridge housing 50 and the rear of the temporary manifold housing plate 60. In an embodiment, temporary manifold housing plate 60 is fitted on the cartridge mount 22 when the manifold housing 30 has yet to be installed. For example, during construction and for testing purposes temporary manifold housing plate 60 is installed and manifold housing 30 and cartridge 24 are removed or have not yet been installed. It will be appreciated that the manifold housing 30 may comprise at least one feature of the temporary manifold housing plate 60, such as alignment means and/or securing means apertures 63.

In an embodiment, the cartridge housing 50 is formed with a key arrangement such that mounting of the manifold housing 30 can only be mounted in predetermined orientation. In this way, the fluid channels can be correctly identified on the manifold housing 30 according to jurisdictional requirements. Conventionally, a hot fluid channel will be disposed on the relative left hand side of the device when viewing the device from a proximal direction. Etchings, depressions or raised formations may also be formed on the manifold housing 30 and/or the manifold 20 to depict or otherwise indicate inlet and or outlet channels.

An expansion recess 53 (FIGS. 4, 6 and 7) may be provided between the attachment plate 54 and the outlet channel 52. The expansion recess 53 may allow for expansion and contraction of the outlet 52 without damaging the manifold 20. Further, movement of the outlet may also be caused by high pressure fluid exiting the mixing chamber 38, and therefore the recess 53 may allow for movement of the outlet 52 without damage to the manifold 20 and/or a substrate 1 to which the manifold is fixed. This is of particular advantage as the potential rapid changes in temperature experienced by the outlet may cause failure of the valve 10 without allowances for expansion and contraction. Further, having the recess within the wall of the manifold will reduce relative movement of the manifold and the substrate, which can cause seals or expansion joints to fail.

First fluid inlet channel 33 is formed from channel portions 33A of cartridge 24 and 33B of cartridge mount 22 collectively. Similarly, second inlet channel 35 is formed from channel portions 35A of cartridge 24 and 35B of cartridge mount 22. In this way, when the cartridge 24 is mounted in the cartridge mount 22, a single first channel 33 is provided, and single second channel 35 is provided. Each of the inlet channels 33B, 35B and the outlet channel 52 may be fixed to an attachment plate 54 which can be fixed to a substrate 1. The substrate 1 may be a wall, or other desired element. In an unillustrated embodiment, the valve 10 may have more than one outlet channel for distribution of fluids from the mixing chamber 38.

First channel portions 33A and 33B form first channel 33, and similarly, the second channel portions 35A and 35B form second channel 35. Each channel 33, 35 may allow a respective first and second fluid to pass therethrough. The hub 37 may direct fluids into the mixing chamber 38 where each of the fluids from the first and second fluid inlet channels 33, 35 mixes to form a mixed fluid. The mixed fluid may then move through the outlet channel 52.

The manifold housing 30 may extend from the adjustment group 40 to the attachment plate 54 at the distal end 3 of the valve 10. In this way, the manifold housing 30 can cover most of the manifold 20 and prevent or reduce fluids or particulate materials from entering the manifold 20. Further, the manifold housing 30 may also provide an insulation shield for the manifold such hot fluid channels cannot be accidentally touched and high temperatures are not transferred to the manifold housing 30. The manifold housing 30 and end cap 32 may also be formed from a metal, or metal alloy, but may also be formed from a polymer or other insulative material. Embodiments of polymer materials may include at least one selected from the group of; phenol formaldehyde resin (Bakelite), neoprene, Acrylonitrile butadiene styrene (ABS), nylon, polyvinyl chloride (PVC or vinyl), polystyrene (PS), polyethylene (PE), polypropylene (PP), polyacrylonitrile, PVB, silicone, Polyoxymethylene (POM), acetal polymers, or any other suitable polymer.

In an embodiment, the manifold 20 is formed at least in part from conventional plumbing component materials such as a metal, or metal alloy, or polymer. For example, common materials may include brass, stainless steel, steel, aluminium alloy, copper, copper alloy, cast iron, galvanised steel, PEX, PVC, CPVC, PP, PE, PBT, Aqua (PEX and aluminium laminations). It will be appreciated that materials selected for the manifold are suitable to contact fluids, such as water for human consumption purposes.

Referring to FIG. 4, there is shown a top down sectional view of an embodiment of a valve 10. The cartridge 24 has been installed in the cartridge mount 22, and is secured in place by securing means 62 in the form of screws or bolts. The adjustment group 40 of the adjustment means 26 extends through an opening in the manifold housing 30, and is accessible by removing cap 32 which is shown as mounted on the manifold housing 30. Faceplate 28 is shown as being installed in generally the same plane as the connection locations (location of grommets 74) between channels 33A and 33B and 35A and 35B. The faceplate 28 is used to hide a portion of the valve 20 and also hide a hole in a wall formed to mount the valve 10. This may further protect the manifold, and prevent persons from accidentally coming into contact with hot fluid channels.

Turning to FIGS. 5 and 6, there is illustrated the manifold cartridge 24 and the manifold cartridge mount 22 as separate items. As can be seen in FIG. 5, the mixing chamber 38 may extend distal (i.e. leftward relative to FIG. 5) the connection of the cavities 34 and 36. Having the mixing chamber 38 extend distal of the grommets 74 in this way provides for a more structurally stable valve as rotation of the cartridge 24 can be restricted or prevented in the case of high pressures being provided to channels 33 and/or 35. Grommets 74 are mounted in annular flanges of respective channels 33, 35 and the mixing chamber 38.

A mixing chamber receptacle 38A is shown in FIG. 6, which receives a distal portion of the mixing chamber 38. The mixing chamber diameter or outer wall generally corresponds to the size of the mixing chamber receptacle 38A such that movement of the cartridge 38 is restricted. Further, the cartridge housing 50 may restrict movement transverse movement of the cartridge when mounted.

FIGS. 7 and 8 show an embodiment of the valve which have been mounted to a substrate 1. The valve 10 as shown in FIG. 7 illustrates an adjustment group 40 of the adjustment means 26 and all other adjustment means components removed. Further, the cavities 34, 36 in the first and second channels are not shown with non-return cartridges 70 or as they may be called, non-return valves 70, and strainers 72. It will be appreciated that the non-return cartridges may optionally be installed, and are not necessary for the valve to function.

The housing 30 can be fixed to the manifold 20 via a securing means. The securing means can be a screw, a fastener, a tongue-in-groove fitting, a magnetic securing means, or any other conventional securing means or mounting means. The end cap may hide the adjustment means 26 such that the adjustment means is not moved unintentionally. The end cap 32 may be mounted on the housing 30 and abut the faceplate 28. The cap may require a lever device or a key to be removed from the housing 30. For example, a screwdriver may be inserted in an aperture in the periphery to remove the cap 32. Alternatively, the cap 32 may be screwed onto the housing 30, or may be secured to the housing via a securing means.

The housing 30 has a proximal end and a distal end. The proximal end being the end in which the cap 32 is mounted, and the distal end being the end which abuts the attachment plate 54 of the cartridge mount 22. The distal end may be formed to at least partially cover the inlet channels such that the potential for the manifold to be accidentally damaged after installation is reduced.

Checking the pressures of the inlets of the valve 10 may be easier as the housing 30 and cartridge 24 need not be installed for direct pressure testing of inlet channels 33 and 35, and outlet 52 since only temporary manifold plate 60 needs to be attached to cartridge housing 22 for pressure testing. This is not possible with conventional tempering valves or mixing valves as they will typically require disconnection of an entire valve system to check pressures. Further, the number of expansion joint seals used with the present system can be greatly reduces at the number of junctions/connections required compared to conventional systems can be reduced. This further reduces the chance for failures to occur, which can be costly to repair, particularly if a failure occurs inside a residence.

In an embodiment, the valve 10 of the present disclosure only required installation of three mechanical joints, such as those to be installed in the cavities 34, 36, whereas conventional valve systems will require more than three and commonly up to eight compression joints to be installed. Removal of these additional compression joints will reduce overall installation time, reduce the potential for leaks to form. The locations of the mechanical joints for the present valve may only be required at inlets 51 and outlet 52.

In one embodiment the mixing valve 10 includes a manifold 20 formed of a cartridge mount 22 and cartridge 24. The manifold 20 defines a first fluid inlet channel 33, a second fluid inlet channel 35, mixing chamber 38 and a fluid outlet channel 52. The first fluid channel 33 may be cold water inlet 33 and the second fluid channel may be a hot water inlet 35 through which cold and hot water, respectively, are delivered into the mixing chamber 38. The mixing chamber 38 is positioned relatively between the inlet channels 33, 35 and the outlet channel 38 is positioned at the end of the mixing chamber 38. A temperature-responsive device 44 is seated in the mixing chamber 38 and, under normal operation, regulates flow of hot and cold fluid to mixing chamber 38 and regulate temperature flow out of the chamber 38 into the outlet channel 52 in embodiments.

In general, mixing valve 10 can be used to deliver tempered water, no water, or cold water, for example, to a fixture such as a shower or sink. It will be appreciated that there are other uses for the valve 10 apart from residential use. Under normal operation, the first inlet channel 33 receives a first fluid and the second inlet channel 35 receives a second fluid. The first and second fluids may be different fluids, and/or may be the same fluids with a temperature and/or pressure differential. For example, cold water enters cold water inlet 33, hot water enters hot water inlet 35, and the two fluids mix in the mixing chamber 38 of the valve 10 such that tempered water of a predetermined maximum temperature can be delivered through outlet 52. In the event that cold water is not supplied to inlet 33 (e.g., cold water supply failure), mixing valve may be adapted to shut off the flow of hot water through outlet 35, thereby reducing the risk of scalding or burns from hot tempered water. In the event that hot water is not supplied to inlet 35 (e.g., hot water supply failure) or temperature-responsive device 44B fails, mixing valve 10 may still continue to supply cold water to outlet 52. Optionally mixing valve 10 may include a dual by-pass mechanism (not shown) that includes a pressure sensing by-pass and a temperature sensing by-pass. In the event that valve 10 cannot deliver tempered fluid, the dual by-pass mechanism provides the valve with a redundant system to deliver cold water to a user.

Cartridge mount 22 and/or the cartridge 24 may be cast, at least in part, from a metal material, such as a bronze, copper or stainless steel for directing cold and hot water to mixing chamber of the second housing portion. First channel 33 is in fluid communication with a first cavity 34, which may be adapted to receive a non-return cartridge. Similarly, the second channel 35 has a second cavity 36 which may receive a non-return cartridge. The first and second channels may be in fluid communication with mixing chamber. First cavity may be a cold water cavity 34 and second cavity may be a hot water cavity 36.

In yet another embodiment, the valve 10 may be an isolation valve. If the valve 10 is an isolation valve, a non-return cartridge can be disposed in the channel of the cold and/or hot fluid channels. In an embodiment, each channel comprises a non-return valve in a predetermined position in the manifold 20. The non-return cartridge 70 prevents, or substantially prevents hot fluids from flowing from the hot fluid channel 35 into the cold fluid channel 33, at least beyond the cavity 34 of the first fluid channel 33. Optionally, strainers may be provided adjacent to the non-return cartridges or in the channels 33, 35 and 52 which may catch solid materials or minerals in the fluid.

It will be appreciated that the cold channel 33 and the hot channel 35 may be used for cold water and hot water, respectively. Each of the channel inlets of the valve may be parallel to each other and meet at a hub 37 which leads to the mixing chamber 38. Fluid may enter the manifold at 51A and 51C of channels 35 and 33, respectively. The fluid from these channels may enter hub 37 via apertures 51B and 51D (identified in FIG. 4). The adjustment means 44, may be adapted to seal at least one of apertures 51B and 51D to prevent a fluid from entering into the hub cavity 37. The mixing chamber 38 may house the mixing tube 46 and the spring 48. The spring 48 may abut a distal end 49 of the chamber 38. A lumen extends between the chamber distal end 49 and the outlet 52. An annular flange 76 may retain the grommet 74 which forms a fluid tight seal between the mixing chamber 38 and the outlet 52.

As cartridge 24 can be removed from the cartridge mount 22, this provides a significant advantage over known valves. Notably, the removable natured of the cartridge 24 allows for at least one of; easy and fast replacement of non-return valves, testing of pressures in channels, replacement of gaskets and/or expansion joints, reductions of the number of expansion joints needed, flushing of channels, cleaning of channels and may also allow for replacement of adjustment means components.

In an embodiment, the lumen of the mixing tube 46 comprises a plurality of ribs 110 (FIG. 2) which allow passage of water from the element 44 into the mixing tube to be mixed and pass through to outlet 52. The ribs 110 may be the only passage for fluids to pass through to the outlet 52. Optionally, the piston 44B also comprises a fluid lumen which may allow fluids to pass into outlet 52.

Temperature-responsive device 38 is responsive to the temperature of water in mixing chamber 36 and expands or contracts axially (arrow T) with the temperature of the water in the mixing chamber. Expansion of piston 44B causes the distal end of the piston 44B to expand towards the outlet 52. In addition, the head 45 may house a portion of the piston 44B which may be adapted to expand towards the channels 33 and/or 35 to reduce the volume of fluid passing into the hub cavity 37 and/or the mixing chamber 38. In this way the pressure and/or temperature can be regulated. For example, piston may expand when hot fluids pass over the piston, and the piston may expand towards the source of hot fluid thus restricting hot fluid flow. In this way, hot water flow decreases and cold water flow increases if the temperature in the hub 37 and/or mixing tube exceeds a predetermined limit. Piston 44B can be a wax thermostatic element, a bimetal sensor, or a liquid-filled thermostatic element, or contain a refrigerant which expands and contracts.

Referring again to FIG. 1, in normal operation, valve manifold 20 provides tempered water of a predetermined maximum temperature through outlet 52 according to the setting of temperature-responsive device (piston 44B). Cold water from a cold water supply flows through cold water inlet 22 and into cold water cavity 40. From cavity 40, the fluid can flow into the hub and then into the mixing chamber.

During operation, temperature-responsive device (piston 44B) responds to the temperature in mixing chamber 38, and expands or contracts appropriately to regulate the temperature of water delivered through outlet 52. If the temperature inside mixing chamber 36 is too hot, piston 44B expands. As a result, the flow of hot water to mixing chamber 36 is reduced, and the flow of cold water to the mixing chamber is increased. If the temperature inside mixing chamber 36 is too cold, piston 44B contracts to widen the gaps between sealing surfaces 86 and 88 and their corresponding seats, and to narrow the gaps between sealing surfaces 56 and 58 and their corresponding seats. As a result, the flow of hot water to mixing chamber 36 is increased, and the flow of cold water to the mixing chamber is reduced. Thus, valve 20 regulates the relative volumes of hot and cold water flow to provide mixed, tempered water of a predetermined temperature to outlet 34.

In the event that cold water is not supplied to the hub (e.g., cold water failure) expansion of piston 44B acts to restrict hot water flow to outlet 52. When the temperature of water in mixing chamber 38 increases above the set predetermined temperature, e.g., about 1° C. to 3° C. above the set temperature, temperature-responsive device (piston 44B) expands. Hot water flowing from hot water channel 35 to outlet 52 is thus limited. As a result, scalding or burns from hot water being provided can be reduced.

When cold water is restored, cold water can flow to hub 37 and/or mixing chamber 38. In response to the cold water flow, temperature-responsive device (piston 44B) contracts to disengage the seals from channel 51D thereby allowing hot water to flow to mixing chamber 36. Valve 10 can then regulate cold and hot water flow to provide tempered water as described above.

Optionally, the device 10 may be adapted to allow at least one of a “cold fluid” in the range of 5° C. to 30° C. to pass through a channel, a “hot fluid” in the range of 60° C. to 99° C. to pass through a channel, a static supply pressure in the range of 1000 kPa to 2000 kPa, and a dynamic supply pressure in the range of 100 kPa to 1000 kPa.

In an embodiment, the outlet channel 52 of the manifold 20 is perpendicular to the inlet channels 33, 35. In at least one illustrated embodiment, the mixing chamber is positioned relatively between the first and second channels 33, 35. In some embodiments, the mixing chamber 38 is positioned between the cavities 34 and 36 of the first channel 33 and second channel 35, respectively.

In another embodiment, the valve 10 may be adapted to be installed in a conventional 64 mm wall cavity and has a depth that will cover the majority of wall and cabinet thickness. In this way the device may be at least partially concealed.

Cartridge 24 is removable from cartridge mount 22 to allow for testing pressures to be carried at for council inspections. This may be advantageous as this may allow for faster servicing times and therefore reduce overall resource consumption.

During construction of a residence, the cartridge 24 may not be installed or may be removed from the cartridge mount 22. In this way the cartridge 24 cannot be damaged if foreign matter (such as wood swarf or metal filings) enters water lines. This is not achievable with conventional valves. Further, having the cartridge removed before final fit off allows the supply water to flow between all hot, cold and mixed water lines. This ensures that all lines are pressurised during construction and that if a line is damaged it is known at the time.

Further, as the valve 10 can be mounted directly to fluid lines, additional interconnecting hoses and/or pipe work is not required. Commonly, interconnecting hoses and/or pipe work is required for installation of conventional art isolation and tempering valves, and therefore the valve 10 of the present disclosure, this cuts down on material and fitting to achieve circulation. Further, this reduced work also reduces overall installation times.

Optionally, the temporary manifold housing plate 60 may be transparent and/or allow viewing whether a cartridge is installed in the cartridge mount. The valve 10 of the present disclosure may eliminates up to a possible of 8 compression joints of a conventional tempering valve when completed at final install. This in turns reduces possible leak in a house/unit or shop where it is intended.

In some embodiments, once the valve 10 is installed no other material is required to complete final install at end of construction. This cuts down cost of material such as copper, nuts and olives (washers) and other various other fitting. The valve may be fully serviceable as the cartridge 24 can be removed from the cartridge mount 22.

In an embodiment, the cartridge 24 is shaped such that installation can only occur in a predetermined way such that incorrectly mounting the cartridge 24 can be avoided. Further, as the valve can be installed in a wall, this significantly reduces the likeness of a plumber or handy person disconnecting the valve 10 and cross connecting the hot to the tempered line to give an end user hot water instead of tempered. This ensures the current country standards are complied with and reducing possible hot water scalding.

In other embodiments, valve 10 can be used for fluids other than water. Terms, such as “top”, “bottom”, “front”, “back”, “downwardly”, and “upwardly”, are used to describe the embodiment as shown in the orientation of the figures, and are not limiting.

Similar to the embodiment as shown in FIG. 1, in a further embodiment, a mixing valve 10 of the present disclosure, the valve includes a circular manifold 20, and a temperature-responsive device 26. The manifold 20 defines first and second fluid inlet channels in the form of a first fluid channel which in the present embodiment comprises a cold fluid channel 33, and a second fluid channel which in the present embodiment comprises a hot fluid channel 35, a mixing chamber 38 in fluid communication with the cold fluid channel 33, the hot fluid channel 35, and a fluid outlet 52 in fluid communication with the mixing chamber 38. The temperature-responsive device 26 is capable of regulating the relative volumes of flow from the fluid inlets 33, 35 to the mixing chamber 38, and therefore to control the flow to the outlet 52. In an embodiment, the manifold 20 is formed from two distinct components, a cartridge mount 22 which connects to infrastructure or fixtures of a structure, and a cartridge 24 which is mountable in the cartridge mount 22.

Referring to FIG. 9, there is illustrated an exploded view of an embodiment of a tempering valve. The valve 10 comprises a circular manifold 20 formed from circular cartridge mount 22 and a cartridge 24. In some embodiments, the cartridge 24 is removable from the cartridge mount 22, such that the pressure at installation of fluid channels can be checked, and/or the fluid channels can be flushed, and/or the fluid channels can be cleaned. An adjustment means 26 is installable in the cartridge 24 of the circular manifold 20. The adjustment means 26 being adapted to regulate or adjust fluid temperature to an outlet of the valve. A circular manifold housing 30 may be disposed over the circular manifold 20. The circular manifold housing 30 may be secured to the circular manifold 20 via an attachment means 62. A circular faceplate 28 may be disposed around a portion of the circular manifold housing 30 and may be used to conceal an aperture or hole in a wall or other substrate. A circular end cap 32 may be attached to a proximal end of the circular manifold housing 30 which covers the adjustment group 40 of the adjustment means 26. It may be an advantage that a circular shape for the manifold 20, circular faceplate 28, circular manifold housing 30, and a circular end cap 32, may be used in some embodiments for ease of manufacture, ease of installation and/or reducing stress of the parts. It may be appreciated that when fitting the device 10 to the wall, it may be easier for a person create a circular aperture rather than any other shaped aperture.

As shown in FIG. 9, an aperture 5 of the circular manifold housing 30 adapted for engaging adjustment group 40 may be offset from the centre of the circular profile of the circular manifold housing 30. A hub 37 of cartridge 24 may be at the longitudinal axis of the adjustment group 40. The first and second fluid inlet channels 33 and 35 in communication with the hub 37 may be positioned within the circular manifold housing 30. It is noted that in some embodiments the first and second fluid inlet channels 33 and 35 are disposed in the second embodiment in FIGS. 9 to 18c at an angle about 45 degrees away from the horizontal plane relative to the hub 37. In the first embodiment shown in FIGS. 1 to 9, fluid channels 33 and 35 are disposed in a common plane whereas in the second embodiment of FIGS. 9 to 18c the first and second fluid inlet channels are each disposed at a 45 degree angle to each other which may assist or aid in reducing the overall bulk of the overall shape of the tempering valve.

The first and second fluid inlet channels 33 and 35 are comprised of first and second channel portions 33B, 35B of cartridge mount 22 in fluid communication with first and second channel portions 33A, 35A of cartridge 24. The circular cartridge mount 22 comprises the first channel portion 33B and the second channel portion 35B. An outlet in the form of outlet channel 52 is provided between the channels 33B and 35B of cartridge mount 22. Entry apertures 51C, 51A of the first and second fluid inlet channels 33 and 35 may be adjacent to the circular manifold 20, and the outlet 52 may be disposed between the first and second fluid inlet channels 33 and 35. In this way, the profile of the manifold 20 can be reduced compared to known devices. Further, this configuration allows pipes or channels to mate with the inlets and outlets of the manifold 20 at a focal point which can be contained in the cavity of a wall.

A plurality of anchor locations 58 are shown disposed on the circular cartridge housing 50 which are adapted to receive securing means 62 for securing a circular manifold housing 30. Each anchor location 58 may receive a discrete securing means 62. The anchor locations 58 may project radially from the circular cartridge housing 50. Circular gaskets 56 may be disposed between the circular cartridge housing 50 and the circular manifold housing 30.

FIG. 10 shows the rear of a circular temporary manifold housing plate 60 which is used without the circular manifold housing 30 and cartridge 24. As will be discussed, the circular temporary manifold housing plate 60 is used to seal the cartridge mount 22 to allow pressure-testing of fluid connections to the inlets 51C and 51A and outlet 52 prior to installing the cartridge 24 into the cartridge mount 22. A plurality of securing means apertures 63 may be provided in the circular manifold housing 30 in which securing means 62 may be mounted or inserted, which are subsequently secured to anchor locations 58. The anchor locations 58 may also have corresponding apertures to allow the securing means 62 to be secured to either the circular temporary manifold housing plate 60 or the circular manifold housing 30. Alternatively, a tongue in groove system or similar securing system may be used instead of a separate securing means passing through apertures.

Circular gaskets 56 or other seal may be provided between the circular temporary manifold housing plate 60 and the cartridge mount 22 to prevent or limit fluid passing undesirably out between the plate 60 and the cartridge mount 22 during pressure testing. The rear of the circular temporary manifold housing plate 60 may have a depression or formation adapted to receive circular gaskets 56. It will be appreciated that circular gaskets 56 may only be present when the circular temporary manifold housing plate 60 is installed. In an embodiment, if a depression or other formation is provided, the formation conforms to the shape of the proximal rim of the circular cartridge housing 50 of the cartridge mount 22. It will be appreciated that the circular manifold housing 30 may comprise at least one feature of the temporary circular manifold housing plate 60, such as alignment means and/or securing means apertures 63. In an embodiment, the temporary circular manifold housing plate 60 is fitted on the circular manifold mount 22 when the circular manifold housing 30 has yet to be installed and without cartridge 24 having been installed. For example, during construction and for testing purposes cartridge mount 22 is initially installed and its entry apertures 51A, 51C are connected to hot and cold water supply with its outlet 52 connected to an outlet pipe. The temporary circular manifold housing plate 60 is then installed and water pressure can then be applied through the hot and/or cold water supply for pressure-testing. Subsequent to successful pressure testing the temporary circular manifold housing plate 60 is removed. The cartridge 24 can then be installed to the cartridge mount 22 and the manifold housing 30, faceplate 28 and end cap 32 put in place.

In an embodiment, the circular cartridge housing 50 is formed with a key arrangement such that mounting of the circular manifold housing 30 can only be mounted in predetermined orientation. In this way, the fluid channels can be correctly identified on the circular manifold housing 30 according to jurisdictional requirements. Conventionally, a hot fluid channel will be disposed on the relative left hand side of the device when viewing the device from a proximal direction. Etchings, depressions or raised formations may also be formed on the circular manifold housing 30 and/or the circular manifold 20 to depict or otherwise indicate inlet and or outlet channels.

Referring again to FIG. 9, similar to the first embodiment of the disclosure that has been described with reference to FIGS. 1 to 8, valve 10 includes an element and piston assembly 44, and a mixing tube 46 disposed in the mixing chamber 38. A shaft of the piston 44B is disposed in the mixing tube 46 which can be axially displaceable relative to the mixing tube 46. The element 44A comprises an annular bottom sealing surface and an annular top sealing surface. Sealing surfaces 45A and 45B of the head 45 are configured to engage the distal end of the hub 37 and the distal end of the adjustment group 40, respectively. Surfaces 45A and 45B are generally configured to controllably restrict flow of fluids from the channels to other parts of valve 10.

The piston 44B is supported in the mixing tube 46, and mixing tube 46 is supported by a return spring 48 located in the mixing chamber 38. In an embodiment, element 44A further defines a plurality of openings (not shown) and a central lumen in fluid communication with the mixing tube 46. When the openings align, or partially align with channel outlets 33B and 335B, the element is considered to be “open”. Central lumen extends through the length of the element 44A and the mixing tube 46 and through to outlet 52.

The element 44A allows for fluids to pass from the first and second channels 33, 35 into the hub, and through to the mixing tube 46 when the valve 10 is open. Optionally, the valve 10 may be closed which prevents mixing of fluids from the first and second channels. Alternatively, when the valve is closed, fluids may be mixed, but repented from exiting the mixing chamber 38 to outlet 52. A relative location of the pressure release piston 44B (which may also referred to as a ‘poppet’) of the element and piston assembly 26 may be adjusted by manipulation of the adjustment group 40. As the adjustment group 40 is turned, the piston 44B may be moved axially within the mixing chamber 38. As the piston 44B axially moves, the mixing tube 46 may also move axially in the mixing chamber 38 relative to the piston 44B. In an embodiment, the displacement of the piston 44B and the displacement of the mixing tube 46 in the mixing chamber and/or hub corresponds to the movement of the adjustment group 40. The spring external the mixing tube may bias the mixing tube 46 against the piston 44B, such that changes in the size of the piston or rotation of the adjustment group 40 retains the piston 44B is a desired location in the mixing tube 46.

It may be appreciated that the device 10 or a tempering valve may mix the hot and cold water that is received into the entries 51A and 51C of the manifold 24 so as to maintain the mixed water at a constant set temperature at the outlet 52. The piston 44B may be a thermostatic element which may be immersed in the mixed water flow. When the temperature changes outside the predetermined/desired temperature value/range of the mixed water, the piston 44B may move surfaces 45A and/or 45B for controlling the passage of hot or cold water at the channels which may adjust the temperature of the mixed water to the desired valve/range.

The piston 44B may have a copper outer surface, which may be conductive for thermal sensing, and the piston 44B may have a resilient honeycomb or hexagonal lattice structure for its inner structure, which may provide the advantage of strengthening or increase the durability of the piston 44B.

Referring now to FIGS. 11 to 16, similar to the first aspect of the disclosure, there are shown sectional views of the device's 10 circular embodiments being assembled and/or installed to a wall. Referring now to FIG. 17, similar to the first aspect of the disclosure, showing a perspective view of the circular embodiment of a cartridge housing with fluid outlet. Referring now to FIGS. 18A to 18C, similar to the first aspect of the disclosure, showing the side views of the circular embodiment of an assembled circular manifold with a cap and faceplate.

An embodiment of a method for tempering hot and cold water supplies will now be described. Initially cartridge mount 22 is fastened in place, for example by screwing attachment plate 54 to a wooden member of a wall frame such as a noggin at a desired position, for example a bathroom or kitchen. A cold water supply pipe is then connected to entry 51c of first channel portion 33B of the cartridge housing 22. Similarly, a hot water supply pipe is connected to entry 51A of the second channel portion 35B of the cartridge mount 22. A mixed water outlet pipe, for example to service a tap of a sink or an outlet of a shower or bath, is then connected to outlet 52 and temporary manifold housing plate 60 is attached to cartridge housing 50 of the cartridge mount 22. The hot and cold supply pipes are then pressurized and a pressure test can be conducted to ensure that relevant building standards are complied with. Subsequent to a successful pressure test, tradespeople such as a plasterer and cabinet maker can work around the cartridge housing with temporary manifold housing plate attached, without requiring a plumber to come back to site to disconnect temporary piping which in the past would have been used to perform the pressure test and which would have obstructed the installation of building material such as plasterboard onto the timber wall frame. In contrast, the presently described method only requires that single hole be made through the plasterboard for accessing the cartridge housing 50 and temporary manifold housing plate 60.

After the plasterer and cabinet maker have finished their work a plumber may revisit the site. The plumber ensures that the hot and cold water supplies are disconnected and then removes the temporary manifold housing plate 60. Cartridge 24 including adjustment means 26 is then installed into cartridge housing 50 of cartridge mount 22. Manifold housing 30 is then installed and faceplate 28 is located over the manifold housing 30. The adjustment group 40 is accessible through a hole in the end of the manifold housing 30 so that a correct mix temperature can be arrived at. End cap 32 can then be placed over the end of the manifold housing 30 to cover the adjustment group 40.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A valve for mixing fluids, the valve comprising;
a manifold having a cartridge mount and a cartridge being mountable in the cartridge mount, and a first fluid inlet channel and a second fluid inlet channel;
the first fluid inlet channel and second fluid inlet channel in fluid communication with a mixing chamber of the cartridge;
an outlet of the cartridge mount being in fluid communication with the mixing chamber, such that the outlet can receive mixed fluid from the first fluid inlet channel and the second fluid inlet channel;
wherein the cartridge is removable from the cartridge mount; and
wherein the valve is further provided with a temporary manifold housing part to seal the cartridge mount when the cartridge is not mounted in the cartridge mount, to thereby allow pressure testing of fluid connections to the cartridge mount when the cartridge is not mounted in the cartridge mount.

2. The valve as claimed in claim 1, wherein the cartridge mount has a first channel portion and a second channel portion, and the cartridge has a corresponding first channel portion and a corresponding second channel portion, in which the first channel portion of the cartridge mount and the corresponding first channel portion of the cartridge form the first fluid inlet channel, and the second channel portion of the cartridge mount and the corresponding second channel portion of the cartridge form the second fluid inlet channel.

3. The valve as claimed in claim 2, wherein a respective interface seal is disposed between the first channel portion of the cartridge mount and the corresponding first channel portion of the cartridge forming the first fluid inlet channel, and between the second channel portion of the cartridge mount and the corresponding second channel portion of the cartridge forming the second fluid inlet channel.

4. The valve as claimed in claim 2, wherein at least one of the corresponding first channel portion of the cartridge and the corresponding second channel portion of the cartridge comprises a cavity.

5. The valve as claimed in claim 4, wherein a non-return valve is provided in at least one of the first and second channel portions of the cartridge.

6. The valve as claimed in claim 1, wherein the manifold comprises a recess which allows for expansion and contraction of the outlet.

7. The valve as claimed in claim 1, wherein the manifold further comprises an attachment plate for fixing the manifold to a substrate.

8. The valve as claimed in claim 1, wherein a manifold housing is mountable over the manifold.

9. The valve as claimed in claim 8, wherein a faceplate is mountable around a portion of the manifold housing.

10. The valve as claimed in claim 1, wherein the valve is adapted to be at least partially mounted in a wall.

11. The valve as claimed in claim 8, wherein the first fluid inlet channel and second fluid inlet channel are in fluid communication with a hub.

12. The valve as claimed in claim 11, wherein an adjustment means is disposed in the hub and mixing chamber of the cartridge.

13. The valve as claimed in claim 12, wherein the adjustment means comprises an element and piston assembly.

14. The valve as claimed in claim 13, wherein a piston of the element and piston assembly is adapted to expand and contract in response to temperature changes, and wherein the adjustment means is adjustable to control a maximum temperature of fluids in the mixing chamber.

15. The valve as claimed in claim 12 wherein the manifold housing comprises an opening providing access to an adjustment group which allows adjustment of the adjustment means, and further comprises a removable end cap to prevent access to the adjustment group when attached to the rest of the manifold housing and to allow access to the adjustment group when attached to the rest of the manifold housing.

16. The valve as claimed in claim 12, wherein the first fluid inlet channel and the second fluid inlet channel are disposed on opposed sides of the hub at an angle 45 degrees to the horizontal plane of the hub.

17. The valve as claimed in claim 12, wherein the first fluid inlet channel and the second fluid inlet channel are disposed on opposed sides of the hub at an angle parallel to the horizontal plane of the hub.

18. The valve as claimed in claim 1, wherein the cartridge housing is provided with a plurality of anchor locations each adapted to receive a securing means, and wherein the temporary manifold housing part is provided with a plurality of securing means apertures, so that in use respective discrete securing means can be mounted in the respective securing means apertures and secured to respective anchor locations to secure the temporary manifold housing part to the cartridge housing.

19. A method for installing a fluid mixing valve comprising:
installing a cartridge mount to a substrate of a building, the cartridge mount including at least first and second fluid inlets and an outlet for a mix of fluids from the first and second fluid inlets and a cartridge housing for receiving a cartridge for mixing fluids from the first and second fluid inlets;
sealing the cartridge housing, when the cartridge is not received in the cartridge housing;
connecting first and second fluid pipes to the first and second fluid inlets and an outlet pipe to the outlet for the mix of first and second fluids;
pressure testing connections of the first and second fluid pipes and the outlet pipe to the cartridge mount while the cartridge housing is sealed; and
after a successful pressure test, unsealing the cartridge housing and installing the cartridge therein.

20. A method according to claim 19 including:
applying a panel over or about a portion of the sealed cartridge housing subsequent to the pressure testing and prior to installing the cartridge.
